(19) United States
(12) Patent Application Publication
(10) Pub. No.: US 2025/0043440 A1
(43) Pub. Date: Feb. 6, 2025

(54) ELECTROLYSIS CELL WITH A CELL CASING MADE FROM METAL FOIL AND ELECTROLYZER

(71) Applicant: thyssenkrupp nucera AG & Co. KGaA, Dortmund (DE)

(72) Inventors: Peter TOROS, Essen (DE); Sebastian AUSTENFELD, Soest (DE)

(73) Assignee: thyssenkrupp nucera AG & Co. KGaA, Dortmund (DE)

(21) Appl. No.: 18/717,785

(22) PCT Filed: Dec. 6, 2022
(86) PCT No.: PCT/EP2022/084554

§ 371 Date: Jun. 7, 2024

(30) Foreign Application Priority Data
Dec. 8, 2021 (EP) 21213031.4

(51) Int. Cl. C25B 9/19; C25B 9/01; C25B 9/05; C25B 9/67; C25B 9/70; C25B 15/02

(52) U.S. Cl. CPC C25B 9/19; C25B 9/01; C25B 9/05; C25B 9/67; C25B 9/70; C25B 15/02

(57) ABSTRACT

An electrolysis cell comprises a cell casing and a sheet-like separator, wherein an anode chamber and a cathode chamber separated by the sheet-like separator are defined by the cell casing and wherein the anode chamber and the cathode chamber comprise an anode and a cathode, respectively, wherein the cell casing comprises at least two sheets of metal foil each having a circumferential rim region, wherein the sheets of metal foil are affixed to each other in the rim regions by an electrically isolating adhesive bond between the sheets of metal foil, and wherein the sheet-like separator is mounted in the cell by being included in the adhesive bond between the rim regions.

### BACKGROUND OF THE INVENTION

The invention relates to an electrolysis cell according to the preamble of claim 1 and an electrolyzer according to the preamble of claim 7.

One type of bipolar electrolyzers for large-scale production (i.e. in the megawatt range) of hydrogen by alkaline water electrolysis and/or chlorine by chlor-alkali electrolysis is the so-called single element design.

In an electrolyzer of single element design, each electrolysis cell is a separately sealed unit. The casing of each electrolysis cell comprises two half-shells, which are bolted together in their rim regions, with a separator and gaskets interposed in-between. Thus, each half-shell forms one half-cell of the electrolysis cell, the half-cells being separated by the separator. The sealing force for sealing the electrolysis cell is provided by the plurality bolts distributed circumferentially along the rim regions of the cell elements. The separator may be an ion exchange membrane, or a porous diaphragm, depending of the intended purpose of the electrolyzer. A short-circuit between the two half-shells forming the casing of each electrolysis cell is to be reliably prevented, for which reason in addition to the gaskets at least one layer of electrically isolating material is interposed in the rim regions before sealing. The electrolysis cells are typically suspended from above in a cell rack and pressed against each other by using a compression device to form a bipolar stack.

DE 196 41 125 A1 shows an example of electrolysis cells of the single element type of bipolar electrolyzers.

The known electrolysis cells of the single element design have the disadvantage that they require a substantial amount of high-grade metallic material, typically nickel and/or titanium, for the cell casing to provide dimensional stability to the single element electrolysis cells. The material strength of the cell casing is chosen such that it is able to support the weight of the cell in operating conditions, i.e. when it is filled with electrolyte. This design results in a considerable weight of the cell casings and high material costs.

### BRIEF SUMMARY OF INVENTION

The object of the invention is to provide a lightweight electrolysis cell with reduced material costs and an electrolyzer able to accommodate such cells.

This object is achieved by an electrolysis cell according to the features of claim 1 and an electrolyzer with the features of claim 7.

Hereby, an electrolysis cell comprising a cell casing and a sheet-like separator is provided, wherein an anode chamber and a cathode chamber separated by the sheet-like separator are defined by the cell casing. The anode chamber and the cathode chamber comprise an anode and a cathode, respectively. According to the invention, the cell casing comprises at least two sheets of metal foil each having a circumferential rim region. The sheets of metal foil are affixed to each other in the rim regions by an electrically isolating adhesive bond between the sheets of metal foil. The sheet-like separator is mounted in the cell by being included in the adhesive bond between the rim regions. An adhesive bond according to this disclosure is any bond maintained by adhesion forces between the joined parts and a bonding material, which provides a connecting element between the joined parts.

Advantageously the inventive electrolysis cell combines a new sealing concept for the cell casing by an adhesive bond with the use of metal foil sheets as the primary material for the cell casing. Thereby, the function of the cell casing is reduced to the purpose of delimiting the chambers of the electrolysis cell in an electrically conductive manner. Dimensional stability of the cell is no longer provided by the cell casing, but only by a cell rack, in which the cell is positioned in an electrolyzer. The use of metal foils reduces the amount and weight of metallic material needed for the casing to a fraction of less than 15% compared to the prior art. Further the sealing by an adhesive bond reduces the weight of the cell, since no bolts nor frame bars are required. The new cell design also facilitates automation of cell assembly.

In certain embodiments of the invention the adhesive bond may be provided by a chemically cured adhesive or a dried solvent-based adhesive. Chemically curing and solvent-based adhesives have the advantage of a particularly strong adhesive bonding, which is able to withstand high temperatures and/or harsh chemicals.

In other embodiments, the adhesive bond is provided by a thermoplastic material. Thermoplastic materials have the advantage that they allow for the possibility to open and re-seal the electrolysis cell in an easy and non-destructive way. For maintenance purposes, as e.g. replacement of the separators, the rim regions can be heated up again until the thermoplastic material is in the thermoplastic state again and the cell elements can be separated. Particularly preferred for sealing the electrolysis cells are thermoplastic materials that contain polypropylene (PP), in particular atactic polypropylene (PP-R), and/or polyvinylchloride (PVC).

Preferably, the sheets of metal foil have a thickness less than or equal to 0.2 mm. Particularly thin metal foils are preferred as cell casing not only to reduce the total amount material required, but also as to improve the flexibility of the cell casing which advantageous for establishing an extensive planar electrical connection of adjacent cells, when a plurality of cells is compressed in a cell stack.

The electrolysis cell may preferably be of rectangular, quadratic, hexagonal or round shape.

In particular, the invention relates to electrolysis cells of industrial scale used for alkaline water electrolysis or chlor-alkali electrolysis. The separator of the electrolysis cell according to the invention therefore preferably has an area of 0.5 m² to 4 m². Further, the electrolysis cell is preferably configured for current densities of at least 3 kA/m².

In embodiments of the invention, the cell casing is coated on the outer side in the rim regions with an electrically isolating layer. An electrically isolating layer in the rim regions of the cell casing is particularly preferred to reduce stray currents in cells to be operated in a tank filled with a barrier liquid. Even if the barrier liquid is chosen to have a high electrical resistance, stray currents at the joint of the rim regions cannot be excluded, in particular if there should occur any contamination of the barrier liquid with electrolyte from within the cells. In such a setup, an electrically isolating coating of the outer sides of the rim regions will be advantageous to reduce stray currents.

The object is further achieved by an electrolyzer comprising a cell rack and a cell stack. The cell stack comprises a plurality of electrolysis cells stacked in an axial direction. The cell rack comprises a compression device for compressing the electrolysis cells of the cell stack in the axial direction in order to maintain electrical connection of the cells in series. The cell stack is mounted in the cell rack with the axial direction extending horizontally. According to the invention, the electrolysis cells in the cell stack are configured described above.

Preferably, the cell rack provides at least one inner boundary surface for the cell stack, which boundary surface provides dimensional stability to the cell stack by supporting the electrolysis cells at least laterally and from below. While the metal foils used for the cell casing are typically robust enough to be handled when the cell is in an empty state, they do not provide for sufficient dimensional stability on their own, when being filled with a liquid electrolyte, i.e. when being in operation. Thus, this function is preferably transferred to the cell rack. The inner boundary surface of the cell rack supporting the electrolysis cells at least laterally and from below achieves a pressure balance between the outside and the inside of the metal foil, such that the boundary surface dissipates the gravitational forces of the electrolyte and/or any additional pressure applied to the electrolyte. The inner boundary surface may either dissipate those forces by being in direct contact with the outer surface of the cell casings, or indirectly by an intermediary medium filling the space between the outer surface of the cell casings and the inner boundary surface of the cell rack.

In preferred embodiments, the cell rack comprises a tank with a tank wall, wherein the cell stack is positioned within the tank and the tank wall forms the at least one inner boundary surface for the cell stack, and wherein the tank is filled with an electrically non-conducting barrier liquid conveying dimensional stability of the cell rack to the cell stack immersed in the barrier liquid. The barrier liquid in the tank is able to provide a pressure balance between a liquid electrolyte in the cell and its outside, thereby relieving the stresses occurring within the material of the metal foil sheets. In particular, it is preferred if the barrier liquid has a density within the range of +/−40% of the density of the liquid electrolyte, in order to achieve a similar height distribution of the pressure due to gravity.

Preferably, the tank is a pressure vessel with a round cross-section. Then the setup allows for an electrolysis at an elevated or even high pressure. The pressure vessel forms an outer protective cover of simple geometry, for which it is comparatively easy to comply with pressure vessel regulations, while the individual cells contained within the vessel do not have to be designed according to those regulations themselves.

Further, it is preferred that the electrolyzer comprises a conductivity sensor for monitoring the electrical conductivity of the barrier liquid. In normal operation, the conductivity of the barrier liquid should be below a specified threshold value. The conductivity rising above this threshold indicates a failure, in particular a leakage from one of the cells, as electrolyte leaking from the cells will increase conductivity of the barrier liquid.

In preferred embodiments, the barrier liquid contains an indicator liquid for indicating leakages of electrolyte from the cell stack by color change. Alternatively or in addition, the pH value of the barrier liquid may be monitored by a pH sensor.

In further preferred embodiments, the tank is connected to a circulation loop of the barrier liquid, wherein the circulation loop comprises a heat exchanger for heating and/or cooling the barrier liquid. Generally, the process of electrolysis generates waste heat. This waste heat may be drawn off, at least in part by cooling the barrier liquid via the heat exchanger. During start up, heating the barrier liquid may be preferred in order to quickly reach a preferred operating temperature.

Advantageously, a pressure sensor is provided to monitor the pressure in the tank, wherein the pressure sensor is connected to a control unit configured to control the pressure of the barrier liquid by adjusting a pressure applied from an external pressure source to the tank. In particular, the pressure control can be used to adjust the pressure of the barrier in the tank to the pressure of the electrolyte in the cells, i.e. as to keep the differential pressure between the inside and the outside of the cells below a specified threshold. The pressure from the external source may be applied by a gaseous auxiliary medium. In particular, an auxiliary medium being inert with respect to the products of the electrolysis is preferred. In case of chlor-alkali or alkaline water electrolysis, e.g. nitrogen is a preferred auxiliary medium.

In other preferred embodiments, the tank is completely filled with the barrier liquid and sealed for an autogenous pressure control of the barrier liquid. Thus, there is essentially no gaseous phase within the tank outside the electrolysis cells. Due to the flexibility of the cell casings, the pressure of the barrier liquid will then automatically follow the pressure of the electrolyte within the cells, wherein the cell casings will deform so as to maintain the pressure balance.

Further advantages of the invention are described in the following with regard to the embodiments shown in the attached drawings.

### BRIEF DESCRIPTION OF DRAWINGS

FIG. 1 shows schematically three electrolysis cells according to the invention,

FIG. 2 shows schematically a first embodiment of the electrolyzer according to the invention, wherein electrolysis cells are stacked supported from the sides and from below by a boundary surface of a cell rack,

FIG. 3 shows schematically a second embodiment of the electrolyzer according to the invention, wherein a stack of electrolysis cells is mounted in a tank filled with a barrier liquid with an external pressure control,

FIG. 4 shows schematically a third embodiment of the electrolyzer according to the invention, wherein a stack of electrolysis cells is mounted in a closed tank filled with a barrier liquid with an autogeneous pressure control,

FIGS. 5A to 5C show schematically three different cell configurations of electrolysis cells mounted in a tank of round cross section.

### DETAILED DESCRIPTION OF INVENTION

In the drawings same parts are consistently identified by the same reference signs and are therefore generally described and referred to only once.

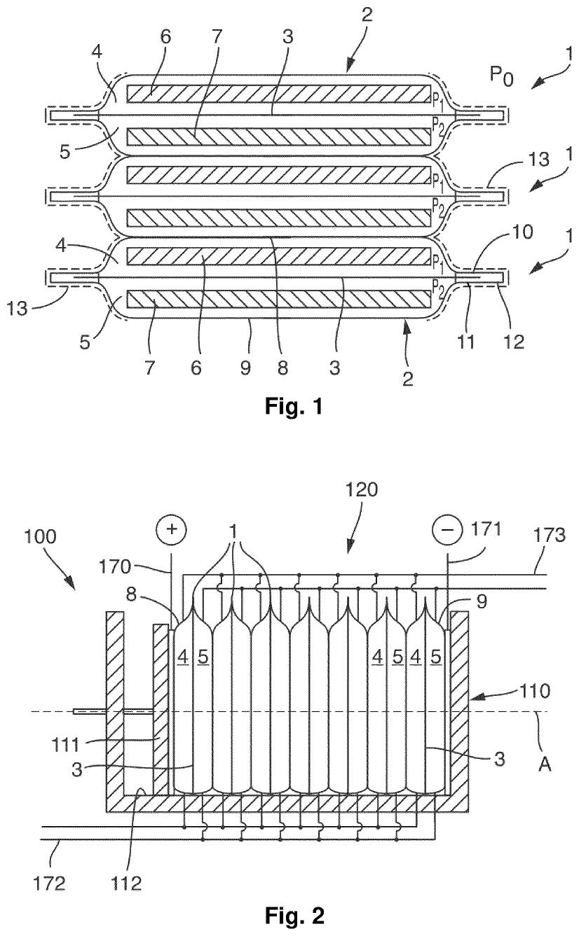

FIG. 1 shows three electrolysis cells 1 according to the invention stacked one upon another. Each electrolysis cell 1 comprises a cell casing 2 and a sheet-like separator 3. An anode chamber 4 and a cathode chamber 5 are defined by the cell casing 2 and separated from one another by the sheet-like separator 3. The anode chamber 4 and the cathode chamber 5 comprise an anode 6 and a cathode 7, respectively.

The cell casing 2 comprises at least two sheets of metal foil 8, 9 each having a circumferential rim region 10, 11. The sheets of metal foil 8, 9 are affixed to each other in the rim regions 10, 11 by an electrically isolating adhesive bond 12 between the sheets of metal foil 8, 9. The sheet-like separator 3 is mounted in the cell by being included in the adhesive bond 12 between the rim regions 10, 11.

Preferably, the sheets of metal foil 8, 9 have a thickness less than or equal to 0.1 mm.

The anode 6 and the cathode 7 are preferably provided by a mesh of wires, in particular a woven mesh. Compared to meshes made from an expanded metal, wires have the advantage not to have sharp edges, which could damage the metal foils 8, 9.

The adhesive bond 12 can be provided by a chemically cured adhesive or a dried solvent based adhesive. Alternatively, the adhesive bond 12 can be provided by a thermoplastic material.

When being stacked upon each other and compressed in an axial direction, the electrolysis cells 1 due to their flexible cell casings 2 of metal foils 8, 9 form an extended contact surface between the anode chamber 4 and the cathode chamber 5 of an adjacent cell 1. On the contact surface there preferably will be a pressure balance between the pressure p1 in the anode chambers 4 and the pressure p2 in the cathode chambers 5. Moreover, there is a pressure balance between the inside pressures p1 and p2 and the outside pressure p0 of the cells 1. Preferably, the pressures p1, p2 and p0 are adjusted as to be equal up to relative differences of 10%, so as to reduce material stress within the sheets of metal foil 8, 9. Preferably, the pressure differences between the pressures p1, p2 and p0 do not exceed 0.5 bar(g).

As shown in FIG. 1, the cell casing 2 is coated in preferred embodiments on the outer side in the rim regions 10, 11 with an electrically isolating layer 13. An isolating layer 13 at the outside of the metal foil 8, 9 in the rim region, in particular in the non-contact area of adjacent cells 1 is helpful to prevent stray current in case of a barrier liquid that is or becomes (e.g. by slight leakage during operation) an imperfect isolating liquid. Of course, due to the requirement that there is a contact surface between adjacent cells 1 there will always be an imperfection at the end of the isolation layer 13 were stray currents could create damages. But the isolating layers 13 reduce the cross-section for stray currents flow and thus reduce the stray currents in general.

In FIG. 2, an electrolyzer 100 comprising a cell rack 110 and a cell stack 120 is shown. The cell stack 120 comprises a plurality of electrolysis cells 1 according to the invention stacked in an axial direction A. The cell rack 110 comprises a compression device 111 for compressing the electrolysis cells 1 of the cell stack 120 in the axial direction A in order to maintain electrical connection of the cells 1 in series. The cell stack 120 is mounted in the cell rack 110 with the axial direction A extending horizontally.

For installing the cells 1 in the cell stack 120 different possibilities exist: For example, the cells 1 can be suspended individually from an upper frame (not shown) of the cell rack 110. Alternatively, the cells 1 can be piled one upon the other while the cell rack is in an upright position with the axial direction A extending vertically. Once all cells 1 of the stack 120 are pre-piled and the compressive force is applied to the stack 120, the whole stack 120 is positioned in the operational state, i.e. with the axial direction A extending horizontally.

The cell rack 110 shown in FIG. 2 provides an inner boundary surface 112 for the cell stack 120, which boundary surface 112 provides dimensional stability to the cell stack 120 by supporting the electrolysis cells 1 at least laterally and from below.

For operation of the electrolyzer 100 a power supply 170, 171 is connected to the outmost cell casings 2 of the stack 120. Further, the anode and cathode chambers 4, 5 of the cells are connected to inlet headers 172 and outlet headers 173 for supply and discharge of electrolyte as well as discharge of the electrolysis products. The inlet and outlet headers 172, 173 preferably extend within the tank 113, as to minimize the number of openings in the tank 113. However, headers external to the tank can also be used, in principle. For the connecting with the inlet and outlet headers 172, 173 fittings of a more solid material are thermowelded to openings within the metal foil sheets 8, 9. These fittings are connected to the headers, e.g. by a threaded connection, hose-nozzle connection or gasket connection.

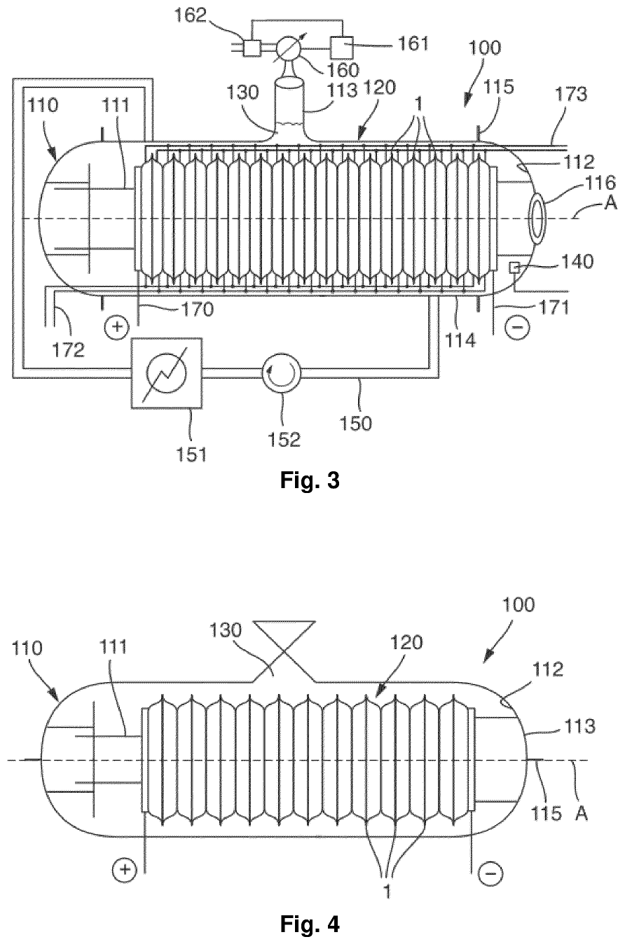

In FIG. 3 a second embodiment of an electrolyzer 100 according to the invention is shown, in which the cell rack 110 comprises a tank 113 with a tank wall 114, wherein the cell stack 120 is positioned within the tank 113. The tank wall 114 forms the inner boundary surface 112 for the cell stack 120. The tank 113 is filled with an electrically non-conducting barrier liquid 130 conveying dimensional stability of the cell rack 110 to the cell stack 120 immersed in the barrier liquid 130. In particular, the tank 113 can be a pressure vessel with a round cross-section. For example, demineralized water can be used as barrier liquid 130.

The tank 113 originally consists of at least two parts that are joined after the cell rack 120 is installed in the tank 113. In the example shown in FIG. 3 the tank 113 is split transversally to the axial direction A in three parts, i.e. a central part and two lids, which are joined together at two flanges 115 by bolting. For installation, the electrolysis cells 1 are preferably hung in a frame (not shown) of the cell rack 120 in an axially moveable manner. Then, the frame is inserted into the open tank 113 from one side. Finally, the tank is closed by bolting of the flanges 115.

The compression device 111 may be positioned completely within the tank 113 as shown in FIG. 3. In this case, tightness of the tank 113 is achieved more easily, which is in particular of advantage if the tank 113 is designed as a pressure vessel. Alternatively, the compression device 111 may extend partly to the outside of the tank 113, for example, having an actuation rod extending to the outside.

The tank 113 is connected to a circulation loop 150 of the barrier liquid 130, wherein the circulation loop 150 comprises a heat exchanger 151 for heating and/or cooling the barrier liquid 130. The circulation loop 150 further comprises a pump 152 for circulating the barrier liquid 130.

For pressure control of the barrier liquid 130, a pressure sensor 160 is provided to monitor the pressure in the tank 113. The pressure sensor 160 is connected to a control unit 161 configured to control the pressure of the barrier liquid 130 by adjusting a pressure applied from an external pressure source 162 to the tank. The external pressure source 162 may provide e.g. an inert gas such as nitrogen to the tank 113. Preferably, the pressure p0 of the barrier liquid 130 is controlled such that it is equal to the pressures p1, p2 within the anode and the cathode chambers 4, 5 up to a relative pressure difference of maximally 10%.

A pressure sensor 160 may also be used to monitor the pressure of the barrier liquid 130, in order to detect incidents such as sudden pressure events (e.g. by small ignitions). The monitoring by a pressure sensor 160 of the barrier liquid 130 in more sensitive than monitoring e.g. the pressure in the outlet headers 173, since the barrier liquid 130 is practically incompressible compared to the gas portions in the outlet headers 173.

The electrolyzer 100 may further comprise a conductivity sensor 140 for monitoring the electrical conductivity of the barrier liquid 130.

Further the barrier liquid 130 contain an indicator liquid for indicating leakages of electrolyte from the cell stack 120 by color change. Such a color change may be recognized e.g. through an inspection window 116 or by using at least partly transparent ducts within the circulation loop 150.

In all other respects, the description of the first embodiment shown in FIG. 2 is applicable to the second embodiment shown in FIG. 3, accordingly.

FIG. 4 shows a third embodiment of an electrolyzer 100 according to the invention. The third embodiment differs from the second embodiment in that the tank 113 is completely filled with the barrier liquid 130 and sealed for an autogenous pressure control of the barrier liquid 130. Thus, the tank 113 does not contain a gaseous phase outside of the cell stack 120 and is not connected a barrier liquid circulation loop. In this case, due to the incompressibility of liquids as compared to gases, the pressure of the barrier liquid 130 will follow the pressure of the media inside the electrolysis cells 1, such that a pressure balance at the cell casings 2 is maintained.

Exemplary, the tank of FIG. 4 is split lengthwise and bolted together at a horizontal flange 115. Joining the tank pieces by welding could also be feasible; however, maintenance of the cell stack 120 would be impaired.

In all other respects, the description of the first and second embodiments shown in FIGS. 2 and 3 is applicable to the third embodiment shown in FIG. 4, accordingly. In particular, the electrolyzer of FIG. 4 will have similar inlet and outlet headers as in FIG. 3, which are not shown for simplicity in FIG. 4.

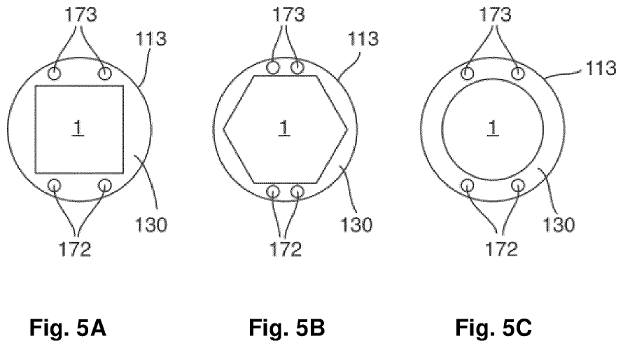

FIG. 5A to 5C illustrate different possible geometries of electrolysis cells 1 within the tanks 113 of the second and third embodiments shown in FIGS. 3 and 4. Generally, due to the use of a barrier liquid 130 to mediate the dimensionally stabilizing effect of the tank wall 114 to the cell casings 2, the cross-section of the cells 1 can be chosen independently of the cross-section of the tank. Within a tank 113 of round cross section, in particular electrolysis cells 1 of rectangular or quadratic shape (FIG. 5A), hexagonal shape (FIG. 5B) or round shape (FIG. 5C) are preferred.

### LIST OF REFERENCE SIGNS

1 electrolysis cell
2 cell casing
3 sheet-like separator
4 anode chamber
5 cathode chamber
6 anode
7 cathode
8, 9 sheet of metal foil
10, 11 rim region
12 adhesive bond
13 electrically isolating layer
100 electrolyzer
110 cell rack
111 compression device
112 boundary surface
113 tank
114 tank wall
115 flange
116 inspection window
120 cell stack
130 barrier liquid
140 conductivity sensor
150 circulation loop
151 heat exchanger
152 pump
160 pressure sensor
161 control unit
162 external pressure source
170, 171 power supply
172 inlet headers
173 outlet headers
A axial direction

1.-15. (canceled)

16. An electrolysis cell, comprising:
a cell casing; and
a sheet-like separator;
wherein an anode chamber and a cathode chamber separated by the sheet-like separator are defined by the cell casing;
wherein the anode chamber and the cathode chamber comprise an anode and a cathode, respectively;
wherein the cell casing comprises at least two sheets of metal foil each having a circumferential rim region;
wherein the sheets of metal foil are affixed to each other in the rim regions by an electrically isolating adhesive bond between the sheets of metal foil;
wherein the sheet-like separator is mounted in the cell by being included in the adhesive bond between the rim regions.

17. The electrolysis cell according to claim 16, wherein the adhesive bond is provided by a chemically cured adhesive or a dried solvent-based adhesive.

18. The electrolysis cell according to claim 16, wherein the adhesive bond is provided by a thermoplastic material.

19. The electrolysis cell according to claim 16, wherein the sheets of metal foil have a thickness less than or equal to 0.2 mm.

20. The electrolysis cell according to claim 16, wherein the electrolysis cell is of rectangular, quadratic, hexagonal or round shape.

21. The electrolysis cell according to claim 16, wherein the cell casing is coated on the outer side in the rim regions with an electrically isolating layer.

22. An electrolyzer, comprising:
a cell rack; and
a cell stack;
wherein the cell stack comprises a plurality of electrolysis cells stacked in an axial direction;
wherein the cell rack comprises a compression device for compressing the electrolysis cells of the cell stack in the axial direction in order to maintain electrical connection of the cells in series;
wherein the cell stack is mounted in the cell rack with the axial direction extending horizontally;
wherein the electrolysis cells are configured according to claim 16.

23. The electrolyzer according to claim 22, wherein the cell rack provides at least one inner boundary surface for the cell stack, which boundary surface provides dimensional stability to the cell stack by supporting the electrolysis cells at least laterally and from below.

24. The electrolyzer according to claim 23, wherein the cell rack comprises a tank with a tank wall, wherein the cell stack is positioned within the tank and the tank wall forms the at least one inner boundary surface for the cell stack, and wherein the tank is filled with an electrically non-conducting barrier liquid conveying dimensional stability of the cell rack to the cell stack immersed in the barrier liquid.

25. The electrolyzer according to claim 24, wherein the tank is a pressure vessel with a round cross-section.

26. The electrolyzer according to claim 24, wherein the electrolyzer further comprises a conductivity sensor for monitoring the electrical conductivity of the barrier liquid.

27. The electrolyzer according to claim 24, wherein the barrier liquid contains an indicator liquid for indicating leakages of electrolyte from the cell stack by color change.

28. The electrolyzer according to claim 24, wherein the tank is connected to a circulation loop of the barrier liquid, wherein the circulation loop comprises a heat exchanger for heating and/or cooling the barrier liquid.

29. The electrolyzer according to claim 24, wherein a pressure sensor is provided to monitor the pressure in the tank, wherein the pressure sensor is connected to a control unit configured to control the pressure of the barrier liquid by adjusting a pressure applied from an external pressure source to the tank.

30. The electrolyzer according to claim 24, wherein the tank is completely filled with the barrier liquid and sealed for an autogenous pressure control of the barrier liquid.
